(19) United States
(12) Patent Application Publication
(10) Pub. No.: US 2024/0199463 A1
(43) Pub. Date: Jun. 20, 2024

(54) Water Treatment System with Improved Efficiency

(71) Applicant: McCoy Water Filter, Inc., Henrico, VA (US)

(72) Inventor: Brian Alexander McCoy, Henrico, VA (US)

(73) Assignee: McCoy Water Filter, Inc., Henrico, VA (US)

(21) Appl. No.: 18/084,120

(22) Filed: Dec. 19, 2022

(51) Int. Cl. C02F 9/00

(52) U.S. Cl. CPC C02F 9/00; C02F 2101/101; C02F 2201/005; C02F 2303/04; C02F 2303/20

(57) ABSTRACT

A pressurized water treatment apparatus and method for use of such apparatus in the treatment of well-water intended for use in a potable plumbing system. The pressurized water treatment apparatus has an inlet port, a check valve, a control valve assembly, an air injection body, a one-way pressure sensitive valve, a treatment tank body, water treatment filter media, gravel media, a distributor basket, a riser tube, and an outlet port. The pressurized water treatment apparatus may be used in four configurations: the normal flow configuration, the backwash configuration, the air injection configuration, and the rinse configuration. When compared to the prior art, the distributor basket and increased total flow area prevents iron and iron bacteria buildup, increasing the efficiency of the water treatment process and use in the backwash configuration, and reducing maintenance and replacement costs.

### FIELD OF THE INVENTION

The invention relates to a method and apparatus for treating water including a distributor basket with an increased total flow area for more efficient backwashing and to prevent the growth of iron bacteria and clogging issues related to iron and iron bacteria.

### BACKGROUND OF INVENTION

The prior art water treatment systems comprise a conventional strainer basket. Conventional strainer baskets have a small slot-opening design. These small slots are used to prevent filter media and gravel media from flowing into the riser tube and into the potable water plumbing system. While the slotted strainers of conventional water treatment systems do prevent small objects from flowing into the riser tube, they do not prevent iron bacteria build up: which reduces the amount of water (and the flow rate of said water) that can flow into and out of the riser tube. Many prior art systems rely upon some form of backwash functionality in cleaning the water treatment system, but the growth of iron bacteria and clogging issues related to iron and iron bacteria make this backwash functionality less effective over time.

Clogged water treatment systems require costly maintenance and often need to be replaced entirely. The efficiency of the backwash is paramount to maintaining an efficient and effective water treatment system. There exists a need for a pressurized water treatment apparatus (and accompanying method of use) which increases the efficiency of the water treatment process, including the cleaning provided during the back wash configuration, and prevents the buildup of iron and iron bacteria in the pressurized water treatment apparatus.

### BRIEF SUMMARY OF THE INVENTION

It is therefore an object of this invention to provide a more efficient method and apparatus for water treatment using a distributor basket to control bacterial growth and remove contaminants, including ferrous bicarbonate, ferric hydroxide, hydrogen sulfide, manganese, sediment, acidity, and odor causing materials from ground water for use in a potable water system.

The prior art is replete with all types of water treatment systems, methods, and apparatus that are susceptible to clogging and reduced efficiency primarily caused by iron and iron bacteria fastening to the interior surfaces of several system components, requiring costly maintenance including dismantling, cleaning, and replacing the media or the entire system. In an embodiment of the present invention, the pressurized water treatment apparatus comprises an inlet port, a check valve, a control valve assembly, a treatment tank body, water treatment filter media, gravel media, a distributor basket, a riser tube, and an outlet port.

In the normal flow configuration, non-aerated water from a well pump is allowed to flow through the pressurized water treatment apparatus, wherein contaminants, including iron bacteria, ferrous bicarbonate, ferric hydroxide, hydrogen sulfide, manganese, sediment, acidity, and odor causing materials, are removed from the water before it is allowed to flow up through the riser tube and into a potable water plumbing system. In the backwash configuration, water is allowed to flow down through the riser tube, and out of the plurality of apertures of the distributor basket, causing iron bacteria, ferric oxides and other contaminants that are fastened to the water treatment filter media to become detached from the particles of the water treatment filter media to be carried upwards and discharged from the pressurized water treatment apparatus.

In the backwash configuration, the substantial aperture size and substantial total flow area provided by the distributor basket allows the water to be moved at a faster more cleansing flow rate to disrupt the buildup of iron and iron bacteria within the pressurized water treatment apparatus than the prior art strainer baskets. The pressure and flow restriction across the conventional strainer baskets prevents effective and efficient backwashing of the water treatment system that eventually leads to contamination and reduced efficiency of the water treatment system. By preventing the buildup and improving cleaning and removal of the iron and iron bacteria, embodiments of the invention reduce the need for maintenance, when compared to the prior art. The present invention also increases the efficiency at which water may be treated and a system that may be backwashed, when compared to the prior art.

In the air injection configuration, the pressurized water treatment apparatus allows air to flow into the treatment tank body, replacing air used in the normal flow configuration and the compressed air pocket released during use in the backwash configuration.

In the rinse configuration, the pressurized water treatment apparatus rinses the water treatment filter media and gravel media and compresses air into a compressed air pocket, preparing the pressurized water treatment apparatus for use in the normal flow configuration.

Aspects of the water treatment systems and methods are presented in various embodiments; however, one skilled in the art will understand various variations and interchangeability of the components of the various embodiments which are intended to be included in the scope of the invention.

### BRIEF DESCRIPTION OF THE DRAWINGS

The above and other objects, features and advantages will be more clearly understood and appreciated from the following Detailed Description of the present invention when taken in conjunction with the accompanying drawings which illustrate the four configurations of the pressurized water treatment apparatus:

FIG. 1 is an elevation of an embodiment of the pressurized water treatment apparatus partially broken away for clarity of illustration, with arrows schematically indicating the direction of water flow during use in the normal flow configuration.

FIG. 2 is an elevation of an embodiment of the pressurized water treatment apparatus partially broken away for clarity of illustration, with arrows schematically indicating the direction of water flow during use in the backwash configuration.

FIG. 3 is an elevation of an embodiment of the pressurized water treatment apparatus partially broken away for clarity of illustration, with arrows schematically indicating the direction of water flow during use in the air injection configuration.

FIG. 3a is an elevation of an enlarged view of the air injection body portion of the control valve assembly which is activated only during use in the air injection configuration of FIG. 3 with arrows schematically indicating the direction of water and air flow during use in the air injection configuration.

FIG. 4 is an elevation of an embodiment of the pressurized water treatment apparatus partially broken away for clarity of illustration, with arrows schematically indicating the direction of water flow during use in the rinse configuration.

### DETAILED DESCRIPTION

The invention relates to a pressurized water treatment apparatus for more efficient removal of contaminants in water. Pressurized water treatment systems depicted in the prior art use conventional strainer baskets to prevent water treatment filter media and gravel media from flowing into the potable water plumbing system. Conventional strainer baskets become clogged and contaminated with iron and iron bacteria through use, which reduces the efficiency of the system. The present invention comprises a distributor basket, which defines a plurality of apertures. Contrary to the teaching of the prior art, the present invention comprises a distributor basket, large apertures (rather than small and thin slots used for straining), and an increase in the total flow area, which improves the rate at which water flows through the present invention and prevents buildup or clogging of iron and iron bacteria through a more efficient backwash configuration.

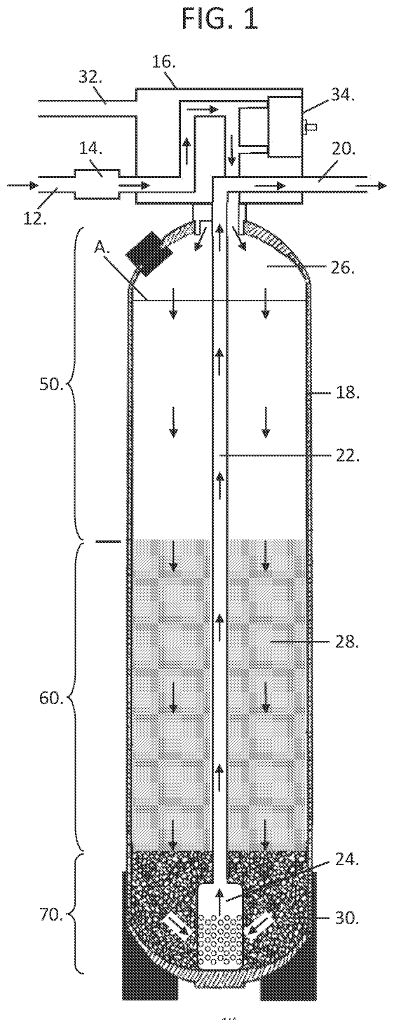

Referring now to FIG. 1, one embodiment of the pressurized water treatment apparatus comprises an inlet port 12, wherein the inlet port 12 is configured to be connected to a pressurized fluid source (not depicted). The pressurized fluid source may be, but is not limited to, non-aerated well water from a well pump or a public water system, for example. The pressurized water treatment apparatus may comprise a check valve 14, which is connected to the inlet port 12. The check valve 14 can prevent the flow of materials back into the pressurized fluid source. For example, the check valve 14 may prevent air from flowing out of the pressurized water treatment apparatus and into a source of non-aerated well water. The pressurized water treatment apparatus comprises a control valve assembly 16. The control valve assembly 16 may be, for example, a Fleck 2510-SXT-AIO Control Valve, although other suitable control valve assemblies with integrated air injection capacity are known in the art. The control valve assembly 16 being in fluid communication with the inlet port 12, and the outlet port 20 being in fluid communication with the control valve assembly 16. The outlet port 20 may be connected to, for example, a potable water plumbing system.

The pressurized water treatment apparatus comprises a treatment tank body 18, the treatment tank body 18 being connected to the control valve assembly 16. The treatment tank body 18 is configured to contain pressurized gases and liquids and water treatment filter media, for example. The treatment tank body 18 may be made from many materials including, but not limited to, plastic, fiberglass, aluminum, steel, metals, or other materials that are capable of containing the pressure of the pressurized fluid source. The treatment tank body 18 may be, for example, a Clack 1354 Dome Hole Mineral Tank, although other suitable treatment tank bodies are well known in the art. The treatment tank body 18 comprises an upper portion 50, a middle portion 60, and a lower portion 70. In an embodiment of the present invention, the various portions of the treatment tank body 18 are not physically separated components. In an embodiment of the invention, the treatment tank body 18 has an inside diameter of between 10 inches and 13 inches and an interior height of between 48 inches and 54 inches. In additional embodiments, the treatment tank body 18 has different dimensions. In an embodiment of the pressurized water treatment apparatus, the control valve assembly 16 is connected to the treatment tank body 18 at the upper portion of the treatment tank body 50. The control valve assembly 16 is configured to regulate the flow of fluid into, out of, and throughout the pressurized water treatment apparatus, and has various configurations, including a normal flow configuration, a backwash configuration, an air injection configuration, and a rinse configuration. The control valve assembly 16 may be automatically or manually controlle.

In the embodiment of the present invention displayed in FIGS. 1-4, the pressurized water treatment apparatus comprises a water treatment filter media 28 and a gravel media 30. The gravel media 30 is in the lower portion of the treatment tank body 70, and the water treatment filter media 28 is in the middle portion of the treatment tank body 60, above the gravel media 30. The gravel media 30 comprises a plurality of particles of gravel. The water treatment filter media 28 comprises a plurality of particles of said media, and the size of those particles is often termed the mesh size in the art but may also be referred to using terms like fine or bulky (with fine referring to smaller particles sizes, and bulky referring to larger particles). In an embodiment of the present invention, the gravel media 30 is bulkier than the water treatment filter media 28, and the water treatment filter media 28 is fine compared to the gravel media 30. In an embodiment of the invention, the water treatment filter media 28 comprises calcium carbonate and may additionally comprise magnesium oxide. In an embodiment of the present invention, the water treatment filter media comprises between 150 lbs and 250 lbs of calcium carbonate (Mesh 10-40) and may additionally comprise between 0 lbs and 5 lbs of magnesium oxide (Mesh P-30). Additional embodiments of the present invention comprise different water treatment filter media 28 including, but not limited to, dolomite, calcite minerals, limestone, crystalline silica quartz, acid buffering materials, materials which are effective in stabilizing dissolved heavy metal species, and combinations thereof. In an embodiment of the present invention, the gravel media 30 comprises between 25 lbs and 75 lbs of quartz gravel (Mesh ⅜× 3/16 inch). The size of the particles in the gravel filter media 30 differs in different embodiments, including, but not limited to, coarse sand (Mesh ¼×⅛ inch). Additional embodiments of the present invention comprise different gravel media 30 including, but not limited to flint, garnet, quartz, rocks, wet materials, glass beads, slags, and combinations thereof.

The pressurized water treatment apparatus comprises a riser tube 22 and a distributor basket 24. The riser tube 22 is located within the treatment tank body 18 and is connected to the control valve assembly 16, extending from the control valve assembly 16 through the upper portion of the treatment tank body 50, through the water treatment filter media 28 in the middle portion of the treatment tank body 60, and into the gravel media 30 in the lower portion of the treatment tank body 70 and is connected to distributor basket 24. In an embodiment of the pressurized water treatment apparatus for residential usage, the riser tube 22 may have an inside diameter of 15/16 inch and an outside diameter of 1 1/16 inches although the riser tube 22 has different dimensions in additional embodiments. The flow area of the distributor basket 24 relates to the rate through which water can flow through the riser tube 22, calculated with the interior diameter of the total circular openings in the distributor basket 24 using the formula for the area of a circle. The flow area of distributor basket 24 produces a flow rate increase in riser tube 22 when water is flowing in either direction through the water treatment apparatus.

The distributor basket 24 is connected to the riser tube 22 in the lower portion of the treatment tank body 70 and is surrounded by the gravel media 30. The distributor basket 24 defines an inner volume, and that inner volume is in fluid communication with the riser tube 22. The distributor basket 24 defines a plurality of apertures. In an embodiment of the invention, the distributor basket 24 has a width of 2.25 inches and the portion of the distributor basket 24 which comprises the plurality of apertures may have a height of 2.5 inches, although these dimensions differ in additional embodiments of the pressurized water treatment apparatus, based upon the configuration and other design restraints. In relation to the plurality of apertures of the distributor basket 24, flow area refers to the area through which materials may flow. In an embodiment of the present invention, each individual aperture in the plurality of apertures has a diameter that prevents the gravel media 30 from entering the inner volume of the distributor basket 24 and flowing up the riser tube 22 to interrupt operation of the control valve assembly 16. In one embodiment of the present invention, the diameter of each individual aperture in the plurality of apertures is less than the diameter of the smallest particle of the gravel media 30 adjacent to the apertures. The flow area of each individual aperture in the plurality of apertures varies between the various embodiments of the present invention. For example, in an embodiment of the invention, the plurality of apertures consists of 209 individual 5/32 inch round drilled holes in a 19×11 helical pattern, and the gravel media 30 is Mesh ⅜× 3/16 inch quartz gravel. The total number and size of apertures in the plurality of apertures also differs in different embodiments.

The plurality of apertures has a size that prevents the gravel surrounding the distributor basket from entering the inner volume of the distributor basket and clogging the riser tube. In some embodiments, the apertures are less ⅜ inch and greater than 0.1 inch. In another embodiment, the apertures are between ⅛ inch and ¼ inch in size. Typically, the apertures will be circular shape and the dimension of the aperture above will be the diameter. However, apertures of any shape may have the smallest opening size in the range above to prevent the gravel from entering the inner volume of the distributor basket.

The size of each aperture, as well as the total number of apertures in the plurality of apertures of the distributor basket 24 contributes to the total flow area of the distributor basket 24. In relation to the distributor basket 24, total flow area refers to the combined (combined flow area of the plurality of apertures) or total area through which materials may flow. In the present invention, the distributor basket 24 may have a total flow area between 2 square inches and 10 square inches. In another embodiment of the present invention, the distributor basket 24 has a total flow area of between 3.8 and 4.2 square inches.

In embodiments of the water treatment system, the distributor basket has a flow area greater than 2 times the flow area of the riser tube of the water treatment system; in a further embodiment, the distributor basket has a flow area greater than 3 times to 6 times the flow area of the riser tube of the water treatment system. In such embodiments, the distributor basket does not restrict flow through the system in a significant amount and allows backwash to become more effective and efficient.

In typical water treatment systems, like those known in the art, a conventional strainer basket is used rather than a distributor basket 24. A conventional strainer basket typically comprises very thin slots, through which water can pass through, these slots usually being stacked in an 8×12 pattern and having the dimension of 0.5 mm×20 mm. The conventional strainer baskets, those known and used in the art, typically have a total flow area of only 1.48 or 1.50 square inches. The total flow area of the conventional strainer baskets used in prior art is significantly less than the total flow area of the distributor basket 24 described in the present invention. Multiple factors contribute the rate at which fluid may flow through a pressurized water treatment system or apparatus, the same is true for the present invention; in the present invention the total flow area of the distributor basket 24 greatly increased the rate at which fluid may flow through the pressurized water treatment apparatus. The restriction through the system is reduced and more water can be pushed through the system from the pressurized water source.

As described herein, the rate at which fluid may flow through a pressurized water treatment system or apparatus is measured in units of Volume per Time, such as GPM, meaning the movement of Gallons of fluid Per Minute. A conventional strainer basket, having total flow area of around 1.5 inches squared, produces a greater restriction and limits the rate at which water can flow through the given system, especially during use in the backwash configuration and when the strainer begins to clog due to particle and bacteria build up. Prior art teaches that minimal flow area and small aperture sizes are required to strain filter media and gravel media from the water in the system and prevent egress into the potable water plumbing system, which is preferable and the purpose of the system. Iron bacteria (IB) are small living organisms that naturally occur in soil, shallow groundwater, and surface waters. These bacteria combine iron (or manganese) and oxygen to form deposits of “rust,” bacterial cells, and a slimy material that sticks the bacteria to well pipes, pumps, and plumbing fixtures. Iron bacteria can create conditions where other disease-causing organisms may grow and can also affect how much water a well can supply due to clogging issues. Over time, the conventional strainer baskets commonly used in the industry develop coatings of IB growth, and that growth causes a decrease in flow capacity of the system. The present invention, a pressurized water treatment apparatus, which comprises a distributor basket 24, does not develop clogging issues due to IB growth.

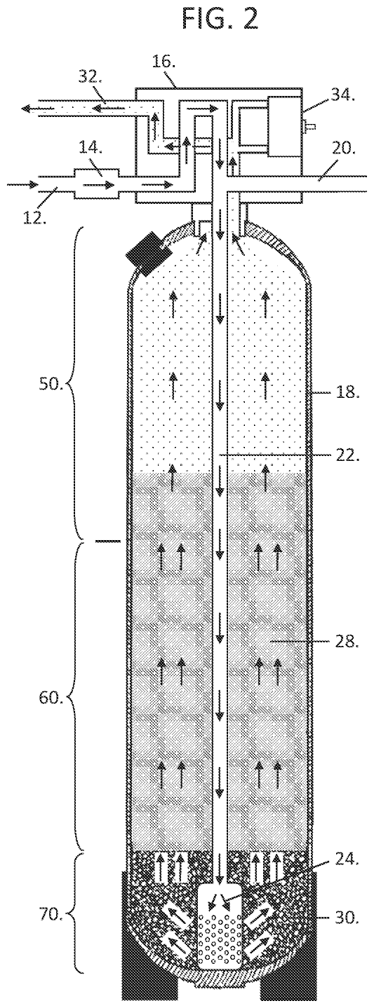

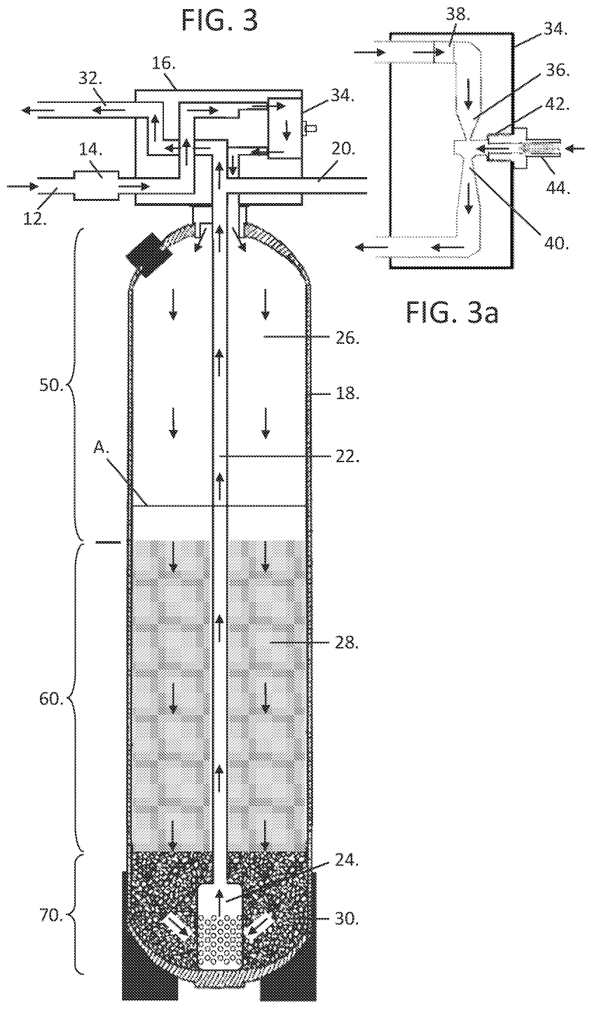

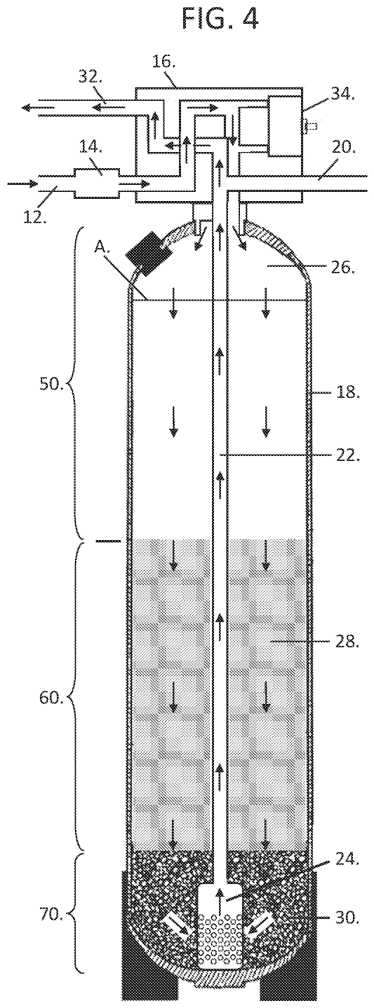

An embodiment of the pressurized water treatment apparatus comprises four configurations which may be used during the water treatment process, the normal flow configuration is depicted in FIG. 1; the backwash configuration is depicted in of FIG. 2; the air injection configuration is depicted FIGS. 3 and 3a; and the rinse configuration is depicted in FIG. 4. Referring now to FIG. 1, in the normal flow configuration, non-aerated well water is drawn from a well pump (not depicted) into the inlet port 12 towards the control valve assembly. The check valve 14 allows water to flow toward the control valve assembly 16 but prevents air from returning to the non-aerated fluid source. In the normal flow configuration, the control valve assembly 16 allows the flow of water into the upper portion of the treatment tank body 50, causing the water to come into contact with the compressed air pocket 26 in the upper portion of the treatment tank body 50. The non-aerated water being exposed to air causes hydrogen sulfide and other materials to be released from the water and captured in the compressed air pocket 26. Oxygen in the compressed air pocket 26 readily dissolves in water under pressure, and the water just below water level A contains dissolved oxygen, ferrous bicarbonate, and ferric oxides.

As the water continues to flow from the upper portion of the treatment tank body 50 to the middle portion of the treatment tank body 60, as depicted by the flow arrows in FIG. 1, the pH of the water is neutralized as it comes into contact with and flows through the water treatment filter media 28. The described oxygen reacts with soluble iron compounds. The oxidation reaction of Fe+2 to Fe+3 produces ferric oxides. The ferric oxides fasten to the water treatment filter media 28 and ferric oxides are captured by the water treatment filter media 28. Additional sediments in the water are also physically captured by the water treatment filter media 28. The water continues to flow through water treatment filter media 28 in the middle portion of the treatment tank body 60 and flows down through the gravel media 30 in the treatment tank body 18. The gravel media 30 may capture and contain filter treatment media 28, completing the filtration process for the water. After the completed filtration process, iron, hydrogen sulfide, sediment, acidity, and odor causing materials have been removed from the water. The treated water continues flowing, through the flow space provided by the plurality of apertures of the distributor basket 24, into the riser tube 22. The water flows through the riser tube 22 from lower portion of the treatment tank body 70, to the control valve assembly 16.

In the normal flow configuration, the control valve assembly 16 allows the water to flow from the control valve assembly 16, through the outlet port 20, and (in some embodiments) into a potable water plumbing system. The water flowing through the outlet port 20 has been treated, removing iron, sulfides, sediments, and other contaminants from the original pressurized fluid source. The normal flow configuration of the pressurized water treatment apparatus allows for the continuous treatment of water for a period of approximately twenty-four to seventy-two hours before the pressurized water treatment apparatus must convert to another configuration; the length of this period is regulated by the control valve assembly 16.

Referring now to FIG. 2, the backwash configuration begins after the normal flow configuration and proceeds for a period of approximately six minutes for a typical water treatment apparatus. The flow rate will vary according to the volumetric dimensions of the treatment tank body as will be further discussed below. The timing, time period, flow rate and flow patterns are regulated by the control valve assembly 16. While the pressurized water treatment apparatus is in the backwash configuration, the flow of water is reversed; meaning water flows down through the riser tube 22. This flow reversal is depicted by the flow arrows in FIG. 2. Non-aerated water flows through the inlet port 12, and the check valve 14, to the control valve assembly 16. In an embodiment of the water treatment apparatus, in the backwash configuration, the control valve assembly 16 allows the non-aerated water to flow into the riser tube 22, instead of into the treatment tank body 18. The water continues to flow down the riser tube 22, into the distributor basket 24, out of the plurality of apertures of the distributor basket 24, into the gravel media 30 in the lower portion of the treatment tank body 70, up through the water treatment filter media 28 in the middle portion of the treatment tank body 60, to the control valve assembly 16. The control valve assembly 16 comprises a discharge port 32, which can allow the flow and release of captured or trapped materials, contaminants, residue, sediments, and fluids, such as the untreated water resulting from the use of the pressurized water treatment apparatus in the backwash configuration.

When the pressurized water treatment apparatus is used in the backwash configuration, the air pocket in the upper portion of the treatment tank body 50 has been saturated with hydrogen sulfide and other contaminants and gases, and that air has been depleted of oxygen, due to the treatment of hydrogen sulfide, ferrous bicarbonate and other contaminants during the normal flow configuration. When in the backwash configuration, the control valve assembly 16 allows the saturated air from the compressed air pocket in the upper portion of the treatment tank body 50 to flow out of the discharge port 32 of the control valve assembly 16. When in the backwash configuration, gases from the compressed air pocket 26 in the upper portion of the treatment tank body 50 escape rapidly through discharge port 32, water flows rapidly out of the plurality of apertures of the distributor basket 24, into the gravel media 30 in the lower portion of the treatment tank body 70 and up through the water treatment filter media 28 in the middle portion of the treatment tank body 60, the water treatment filter media 28 is lifted vertically in the treatment tank body 18. The particles of the water treatment filter media 28 are small and densely packed together, the particles are in close contact with one another which causes rubbing, scouring, and abrasion. This rubbing, scouring, and abrasion, along with the upward motion caused by the flowing water, causes iron bacteria, ferric oxides and other contaminants that are fastened to the water treatment filter media 28 to become detached from the particles of the water treatment filter media 28. Once detached from the particles of the water treatment filter media 28, those iron bacteria, ferric oxides and other contaminants are carried away with the flow of water, upwards through the treatment tank body 18, towards the control valve assembly 16 where they are discharged through the discharge port 32 of the control valve assembly 16. The discharge released from the discharge port 32 of the control valve assembly 16 can be monitored, and, in some embodiments of the invention, the period in which the pressurized water treatment apparatus is in backwash configuration can be extended or shortened to achieve a clear discharge (which indicates that the backwash configuration has succeeded in washing out remaining contaminants). After the pressurized water treatment apparatus has been in use for a few weeks, the discharge resulting emanating from the discharge port 32 of the control valve assembly 16 resulting from the backwash configuration should be clear at first, then darken, turning orange or brown, depending upon the amount of iron in the contaminants being discharged. Thereafter, the discharge emanating from the discharge port 32 resulting from the backwash configuration should become clear again.

Ensuring a high rate at which water is able to flow through the pressurized water treatment apparatus (GPM) is essential to the efficient use of the present invention in the backwash configuration. The backwash configuration relies upon the water being moved with enough force to sufficiently move the water treatment filter media 28 to cause the particles of the water treatment filter media 28 to rub together and release iron bacteria, ferric oxides other contaminants that are fastened to the water treatment filter media 28. The flow rate is initially high due to the release of the compressed air pocket in the upper portion of the treatment tank body 50 increasing the rubbing, scouring, and abrasion. The rubbing, scouring, and abrasion caused by this movement releases iron and iron bacteria that is fastened to the water treatment filter media 28, effectively controlling the growth of iron bacteria. The GPM must also be sufficient to push the water treatment filter media 28 upwards in the treatment tank body 18, to allow room for the iron bacteria, ferric oxides, iron-containing particles, and other contaminants to be carried away. Unlike the pressurized water treatment systems commonly used in the industry, the present invention also utilizes the backwash configuration to effectively dislodge iron and iron bacteria (IB) from the distributor basket 24, the gravel media 30 and the water treatment filter media 28, preventing buildup of IB growth in the water treatment system. In a typical pressurized water treatment system with a conventional strainer basket, like those commonly used in the industry, the total flow space is 1.5 square inches which results in a pressurized water treatment system which has a GPM of 6.9, in a completely clean condition, when used in its (rough) equivalent to a backwash configuration. It is well known in the art that around 7 GPM is the target for such a system; on its face, the industry standard seems almost sufficient. Over time, sometimes not long after installation, iron and IB begin to buildup on the conventional strainer basket of the industry standard system. As more IB grows on the conventional strainer basket, the GPM of the system decreases further, which causes more IB growth, and the cycle continues. A pressurized water treatment system with significant IB growth typically has a backwash GPM of around 3.5 or less. This reduction in GPM reduces the overall efficiency of the pressurized water treatment system and increases costs, requiring additional maintenance, and increasing the risk of contamination.

The present invention, comprising a distributor basket, when in backwash configuration also eliminates the issue of IB growth through increased total flow area. The control valve assembly 16 of the pressurized water treatment apparatus comprises a flow restrictor (not depicted), connecting the pressurized water treatment apparatus to the discharge port 32. The flow restrictor is typically set 7 GPM for use in the backwash configuration. Flow restrictors and the use thereof are well known in the art. Water moves through a 7 GPM flow restrictor at 7 GPM. Air moves through a 7 GPM flow restrictor at a much higher rate: at rates of 10 GPM or more. Due to the significantly increased total flow area when compared to the prior art, during the first few seconds of use in the backwash configuration during release of the air pocket, when the saturated air in the compressed air pocket 26 is released during use of the pressurized water treatment apparatus in the backwash configuration, the water within the treatment tank body is able to flow at rates matching or nearly matching the pump rate of the attached well pump: at rate of 10 GPM or more. The increased GPM causes more lifting and more abrasion of the particles of the water treatment filter media 28. This increase in the flow of water also dislodges and pushes upwards any iron or IB that may be present in the gravel media 30 or the water treatment filter media 28. Once dislodged, the iron and IB may be carried away with the flow of water out of the treatment tank body. The dislodging of iron and IB is essential to ensuring that IB clogging does not occur in the water treatment system, and the present invention efficiently ensures just that. Prior art taught that conventional strainer baskets and their slot design were preferable because having smaller openings in the conventional strainer with a smaller total flow area prevented the risk of filter treatment media 28 or gravel media 30, from flowing up through (the rough equivalent of) the riser tube 22 and into the potable water plumbing system. The present invention defies that teaching, instead utilizing a significantly higher total flow area and large apertures in a distributor basket 24 to produce a stronger flow of water (i.e. higher GPM) during use in the backwash configuration which removes IB from the distributor basket 24, surrounding gravel media 30 and the water treatment filter media 28 before IB growth has a chance to contaminate and clog the water treatment system. The distributor basket 24 does not clog with iron bacteria like the conventional strainer baskets of the prior art, but ensures an efficient backwash to prevent buildup of iron bacteria in the water treatment system and egress of sediment and contaminants (like, IB) into the potable water plumbing system.

Referring now to FIG. 3 and FIG. 3a, after the backwash configuration is used, the pressurized water treatment apparatus may be converted to the air injection configuration. In an embodiment of the invention, the air injection configuration is typically used for a period of twenty-two minutes, although this period differs in different embodiments. While used in the air injection configuration, the timing, period length, flow rate and flow pattern can be regulated by the control valve assembly 16. The flow rate will also vary according to the volumetric dimensions of the treatment tank body 18. The pressurized water treatment apparatus being in the air injection configuration involves the introduction of water and uncontaminated air into the pressurized water treatment apparatus. Non-aerated well water is draw from non-aerated fluid source into the inlet port 12, past the check valve 14 and towards the control valve assembly 16. The control valve assembly 16 comprises an internal bypass (not depicted) and an air injection body portion of the control valve assembly 34. The air injection body portion of the control valve assembly 34 comprises a screen 38, a venturi nozzle 36, a venturi throat 40, a bore 42 and a one-way pressure sensitive valve 44. When water flows from the inlet port 12 to the control valve assembly 16, the internal bypass of the control valve assembly 16 is closed, allowing water to flow through screen 38 for removing particulate matter in the water that could possibly clog the venturi nozzle 36. As water passes from the venturi nozzle 36 to the venturi throat 40, a pressure differential is created at the bore 42. The bore 42 accepts a one-way pressure sensitive valve 44. The pressure sensitive valve 44 opens in response to the pressure differential, which allows ambient air to enter the bore 42. The one-way pressure sensitive valve 44 allows air to flow into the pressurized water treatment apparatus and prevents water and air from flowing out. The one-way pressure sensitive valve 44 may be, for example, a Light Spring Schrader Valve color coded white, orange or green. The control valve assembly 16 allows this aerated water to flow into the upper portion of the treatment tank body 50. Pressure inside the treatment tank body 18 drops as the aerated water flows from the upper portion of the treatment tank body 50, through the water treatment filter media 28 in the middle portion of the treatment tank body 60, through the gravel media 30 in the lower portion of the treatment tank body 70, through the plurality of apertures of the distributor basket 24, up through the riser tube 22, to the control valve assembly 16, and out of the discharge port 32. As the aerated water flows into the upper portion of the treatment tank body 50, air is released from the water to form an air pocket 26, and water rinses the water treatment filter media 28. In air injection configuration, the control valve assembly 16 regulates the water level above the water treatment filter media 28; in one embodiment of the invention, the water level is set 1½ inches above the water treatment filter media 28 when the air injection configuration is terminated.

Referring now to FIG. 4, after use of the pressurized water treatment apparatus in the air injection configuration, the pressurized water treatment apparatus may be converted to the rinse configuration. In an embodiment of the invention, the rinse configuration is in use for a period of four minutes. While used in the rinse configuration, the timing, period length, flow rate and flow pattern can be regulated by the control valve assembly 16. The flow rate will also vary according to the volumetric dimensions of the treatment tank body 18. The rinse configuration involves bypassing the air injection body portion of the control valve assembly 34. Non-aerated well water is drawn from a well pump into the inlet port 12 towards the control valve assembly 16. The check valve 14 allows water to flow toward the control valve assembly 16 but prevents any air from returning to the non-aerated fluid source. In the rinse configuration, the control valve assembly 16 allows the flow of water into the upper portion of the treatment tank body 50. The air pocket is compressed as the non-aerated water flows from the upper portion of the treatment tank body 50 through the water treatment filter media 28 in the middle portion of the treatment tank body 60, through the gravel media 30 in the lower portion of the treatment tank body 70, through the plurality of apertures of the distributor basket 24, up through the riser tube 22, to the control valve assembly 16, and out of the discharge port 32. During this process, the water treatment filter media 28 is compressed into a tightly packed state and the pressure in the treatment tank body 18 rises until a cut-off point, that cut-off point being regulated by the well pump system.

After the pressurized water treatment apparatus has been used in the rinse configuration, the pressurized water treatment apparatus may be converted to the normal flow configuration. The four configurations: normal flow configuration, backwash configuration, air injection configuration, and rinse configuration may be used in a cycle to maintain the efficiency of the pressurized water treatment apparatus.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A pressurized water treatment apparatus comprising,
an inlet port, wherein the inlet port is configured to be connected to a pressurized fluid source;
a check valve, the check valve being connected to the inlet port to prevent the flow of materials into the pressurized fluid source;
a control valve assembly, the control valve assembly being connected to the inlet port, the control valve assembly regulating the flow of fluid through the normal flow configuration, the backwash configuration, the air injection configuration and the rinse configuration;
an air injection body, the air injection body being an integrated portion of the control valve assembly;
a one-way pressure sensitive valve, the one-way pressure sensitive valve being connected to the air injection body;
a treatment tank body, the treatment tank body defining an upper portion and a middle portion and a lower portion, the upper portion of the treatment tank body being connected to the control valve assembly;
a compressed air pocket, the compressed air pocket being located within the upper portion of the treatment tank body;
a water treatment filter media, the water treatment filter media comprising a plurality of particles, the water treatment filter media being located within the middle portion of the treatment tank body;
a gravel media, the gravel media comprising a plurality of particles of gravel, the gravel media being located below the water treatment filter media within the lower portion of the treatment tank body;
a riser tube, the riser tube being located within the treatment tank body, the riser tube being connected to the control valve assembly, the riser tube extending from the control valve assembly through the upper portion of the treatment tank body and through the water treatment filter media in the middle portion of the treatment tank body and the gravel media in the lower portion of the treatment tank body;
a distributor basket, the distributor basket being connected to the riser tube in the lower portion of the treatment tank body, the distributor basket being surrounded by the gravel media, the distributor basket defining an inner volume and that inner volume being in fluid communication with the riser tube, the distributor basket comprising a plurality of apertures, the distributor basket having a total flow area between two and ten square inches; and
an outlet port, the outlet port being connected to the control valve assembly, the outlet port connecting the control valve assembly to a potable water plumbing system.

2. The pressurized water treatment apparatus of claim 1, wherein the pressurized fluid source comprises non-aerated well water from a well pump.

3. The pressurized water treatment apparatus of claim 1, wherein the outlet port may be connected to a residential or commercial potable water plumbing system.

4. The pressurized water treatment apparatus of claim 1, wherein the control valve assembly comprises a Fleck 2510-SXT-AIO control valve.

5. The pressurized water treatment apparatus of claim 1, wherein the air injection body is an integrated portion of the control valve assembly.

6. The pressurized water treatment apparatus of claim 1, wherein the one-way pressure sensitive valve comprises a Light Spring Schrader Valve.

7. The pressurized water treatment apparatus of claim 1, wherein the treatment tank body comprises a Clack 1354 Dome Hole Mineral Tank.

8. The pressurized water treatment apparatus of claim 1, wherein the compressed air pocket comprises ambient air.

9. The pressurized water treatment apparatus of claim 1, wherein the water treatment filter media comprises Mesh 10-40 Calcium Carbonate.

10. The pressurized water treatment apparatus of claim 1, wherein the water treatment filter media comprises Mesh 10-40 Calcium Carbonate and Mesh P-30 Magnesium Oxide.

11. The pressurized water treatment apparatus of claim 1, wherein the water treatment filter media comprises between 150 lbs and 250 lbs of calcium carbonate and additionally comprises between 0 lbs and 5 lbs of magnesium oxide.

12. The pressurized water treatment apparatus of claim 1, wherein the gravel media comprises Mesh ⅜× 3/16 inch Quartz Gravel.

13. The pressurized water treatment apparatus of claim 1, wherein the gravel media comprises between 25 lbs and 75 lbs of quartz gravel.

14. The pressurized water treatment apparatus of claim 1, wherein the riser tube comprises an interior diameter of 15/16 inches and an outside diameter of 1 1/16 inches.

15. The pressurized water treatment apparatus of claim 1, wherein the distributor basket comprises a width of between 1.80 inches and 2.70 inches.

16. The pressurized water treatment apparatus of claim 1, wherein the distributor basket allows a backwash flow rate of at least 7 GPM.

17. The pressurized water treatment apparatus of claim 1, wherein the distributer basket comprises a plurality of apertures, each individual aperture having a diameter that is smaller than the diameter of the plurality of gravel particles.

18. The pressurized water treatment apparatus of claim 1, wherein the total flow area of distributor basket is between 3.8 and 4.20 square inches.

19. The pressurized water treatment apparatus of claim 1, wherein the total flow area of distributor basket is at least three times greater than the flow area of the riser tube.

20. The pressurized water treatment apparatus of claim 1, wherein the total flow area of distributor basket is at least five times greater than the flow area of the riser tube.

21. The pressurized water treatment apparatus of claim 1, wherein the plurality of apertures of the distributor basket defines diameter apertures between 0.1 inch and 375 inches.

22. A pressurized water treatment apparatus comprising,
an inlet port, wherein the inlet port is configured to be connected to a pressurized fluid source;
a check valve, the check valve being connected to the inlet port to prevent the flow of materials into the pressurized fluid source;
a control valve assembly, the control valve assembly being connected to the inlet port, the control valve assembly regulating the flow of fluid through the normal flow configuration, the backwash configuration, the air injection configuration and the rinse configuration;
an air injection body, the air injection body being an integrated portion of the control valve assembly;
a one-way pressure sensitive valve, the one way pressure sensitive valve being connected to the air injection body;
a treatment tank body, the treatment tank body comprising an upper portion and a middle portion and a lower portion, the upper portion of the treatment tank body being connected to the control valve assembly;
a compressed air pocket, the compressed air pocket being located in the upper portion of the treatment tank body;
a water treatment filter media, the water treatment filter media comprising a plurality of particles, the water treatment filter media being located within the middle portion of the treatment tank body;
a gravel media, the gravel media comprising a plurality of particles of gravel, the gravel media being located below the water treatment filter media within the lower portion of the treatment tank body;
a riser tube, the riser tube being located within the treatment tank body, the riser tube being connected to the control valve assembly, the riser tube extending from the control valve assembly through the upper portion of the treatment tank body and through the water treatment filter media in the middle portion of the treatment tank body and the gravel filter media in the lower portion of the treatment tank body, the riser tube having a riser tube flow area;
a distributor basket, the distributor basket being connected to the riser tube in the lower portion of the treatment tank body, the distributor basket being surrounded by the gravel media, the distributor basket defining an inner volume and that inner volume being in fluid communication with the riser tube, the distributor basket comprising a plurality of apertures, the distributor basket having a total flow area between two and six times the riser tube flow area;
and an outlet port, the outlet port being connected to the control valve assembly, the outlet port connecting the control valve assembly to a potable water plumbing system.
